(19) United States
(12) Patent Application Publication
(10) Pub. No.: US 2010/0330860 A1
(43) Pub. Date: Dec. 30, 2010

(54) Absorbent Hygiene Product

(76) Inventors: Eckhard Puerkner, Duesseldorf (DE); Achim Schmitt, Leichlingen (DE); Heinrich Träger, Meerbusch (DE); Holger Toenniessen, Niederzier (DE)

Correspondence Address: Henkel Corporation, 10 Finderne Avenue, Suite B, Bridgewater, NJ, 08807, US

(21) Appl. No.: 12/874,429

(22) Filed: Sep. 2, 2010

Related U.S. Application Data
(63) Continuation of application No. PCT/EP09/50815, filed on Jan. 26, 2009.

(30) Foreign Application Priority Data
Mar. 3, 2008 (DE) 10 2008 012 247.5

(51) Int. Cl. C09J 7/04; D04H 13/00; C09J 7/00; B32B 38/00; B32B 38/14

(52) U.S. Cl. 442/398; 442/327; 428/345; 156/273.3

(57) ABSTRACT

A multiple-ply fluid-absorbing hygiene item for use in a garment, the item comprising an outer layer; said outer layer comprising a layer of a UV-crosslinking pressure-sensitive adhesive; the pressure-sensitive adhesive being crosslinked from a liquid pressure-sensitive adhesive precursor by UV radiation; the pressure-sensitive adhesive precursor having, at a temperature of at most 80° C., a viscosity below 5000 mPas.

### CROSS-REFERENCE TO RELATED APPLICATIONS

The present application is a continuation of International Application No. PCT/EP2009/050815 filed 26 Jan. 2009, which claims the benefit of German Patent Application No. 10 2008 012 247.5, filed 3 Mar. 2008.

The present invention relates to an absorbent hygiene item. The invention further relates to a method for manufacturing such hygiene items.

Absorbent hygiene items, such as underwear inserts or incontinence products, are known on the market. The manufacture and construction of such hygiene items are likewise known in a variety of configurations. It has proven to be useful for the outer side of such hygiene items to be coated with a pressure-sensitive adhesive in order to ensure secure fitting of such products.

A requirement applied to the corresponding pressure-sensitive adhesives is that adhesion on the outer side of the item is to be as stable as possible; on the other side, adhesion to the garment is to be immovable to the extent that slippage of the item is avoided as far as possible. Assurance is to be given, however, that upon removal of the hygiene product, substantially no adhesive adheres to the surface of the garment.

WO 2006/071161 describes absorbent items that are made up of multiple layers. A layer of a UV-hardening adhesive is applied on the outer side, the adhesive being hardened by UV irradiation using different radiation doses. The pressure-sensitive adhesives (PSAs) described therein are applied onto the hygiene item as a hot melt adhesive.

EP 0784459 is also known. This describes multiple-ply absorbent hygiene items, a layer of a pressure-sensitive adhesive being applied on the outer side. Elastomeric hot melt adhesives based on SBS or SIS copolymers are described as adhesives.

Nonreactive hot adhesives of this kind are applied in the melted state, and upon cooling then form a tacky, adhesive layer. The application of such hot melt adhesives is usually accomplished at temperatures above 130° C. The viscosity of the adhesives at these temperatures is so low that they can be applied onto the substrate in thin layers using known application methods.

A substantial disadvantage of these adhesives that are applied hot is that the method for melting, delivering to the applicators, and application are energy-intensive. In addition, corresponding measures must be taken in terms of stability of the processing equipment with regard to heat. A further utilization disadvantage is the fact that the corresponding hygiene products are intended to be as flexible as possible. For this purpose, plastic films that are as thin as possible usually must also be used as an outer coating ply. Such films are, however, thermally sensitive; for example, the softening temperature of polyethylene (as LDPE) is below 120° C. As a result, limits are thus placed on the utilization of melt adhesives, or thermally stable films must be used.

The object of the present invention is therefore to make available fluid-absorbing hygiene items, the outer side of the hygiene item being made of a thin layer that is coated with a UV-crosslinking pressure-sensitive adhesive, the pressure-sensitive adhesive being capable of being applied at low temperature.

The subject matter of the present invention is therefore a multiple-ply fluid-absorbing hygiene item for use in a garment, the item comprising an outer layer; a layer of a UV-crosslinking pressure-sensitive adhesive being applied on said outer layer; the pressure-sensitive adhesive being manufactured from a liquid pressure-sensitive adhesive precursor by crosslinking with UV radiation; and the pressure-sensitive adhesive precursor having, at a temperature of at most 80° C., a viscosity below 5000 mPas.

The subject matter of the invention is furthermore a method for manufacturing a multiple-ply fluid-absorbing hygiene item; the hygiene item being manufactured in a manner known per se; a film being applied on the outer side; and a liquid pressure-sensitive adhesive precursor being applied onto said film at temperatures below 80° C., said layer being crosslinked by UV radiation to yield a pressure-sensitive adhesive.

Fluid-absorbing sanitary products are generally made up of a variety of layers that each make available specific properties for that product. Located on the inner side (the side facing toward the body) is usually a cover layer. It is permeable to water. Located below said cover layer is an absorbent core. It can be joined to the cover layer using adhesives known per se. An outer layer (back sheet) is provided as a further necessary layer. This serves as a carrier material for the absorbent hygiene article. It is joined to the other constituents by means of adhesive and optionally impressing. If applicable, it is possible to utilize additional further inner layers in order to achieve particular use properties. The materials and adhesives for adhesive bonding of the various layers to one another are known to the skilled artisan.

The outer layer is subject to the requirement that it be impermeable to moisture. It is advantageous, however, if it is breathable, i.e. allows gases or even water vapor to pass through. The outer layer can be manufactured on the basis of fibers, or can involve films. The layer can be strong in tension, or has some elasticity. It is necessary, however, for this layer to be of flexible configuration and also tear-proof.

Layers made of fibers, for example polyolefin fibers such as PP or PE fibers, two-component fibers, or polyester fibers, such as polyethylene terephthalate fibers, are known, for example, The fiber materials must be joined to one another in such a way as to produce a dense, hydrophobic layer. These can be nonwoven fibers or even a solid fabric, but the latter must have a high level of flexibility.

Films are a further material for manufacture of the outer layer. These are substantially elastic films, based e.g. on thermoplastic elastomers. Examples of such polymers are styrene block copolymers such as SBS, SIS, SEBS, SIBS, elastomeric polyurethanes, polyesters, polyethers, polyester amides, EVA, flexible rubber materials such as EBR or SBR rubber, or in particular polyolefins such as polypropylene, polyethylene, and copolymers. They often have a softening point of up to 130° C. Polyolefin films have proven to be particularly suitable, for example those made of LDPE or LLDPE that possess a low softening point. This softening point is intended, in particular, to be below 120° C. (measured using the ring and ball method, DIN 52011). The films or the fabric are to be hydrophobic. Pores, for example, can, however, be contained. Various subregions having hydrophilic properties can furthermore be contained.

In a further embodiment, the film material can also be made up of polyolefins mixed with other polymers, e.g. EVA. This film material is likewise very flexible; it can have a softening point below 100° C.

The thickness of the outer layer is 5 to 500 μm, in particular up to 100 μm. Particularly preferably, the layer thickness can be 10 to 30 μm. The outer layer can be smooth, it can be impressed, or it can have structures resulting from its manufacture.

One property of the outer layer is the fact that it is hydrophobic. Liquids are intended thereby to be retained on the inner side in the absorbent core. The advantageously present breathability of the outer layer can be achieved by polarity of the materials, by a structure of the layer material, or by means of pores in the layer. Such materials, including in particular films, are commercially obtainable.

A liquid pressure-sensitive adhesive precursor that is suitable according to the present invention is applied onto the outer layer. This precursor is to be applicable at low temperatures, i.e. the viscosity is to be below 5000 mPas at temperatures of up to 80° C. If the viscosity is too high, the selection of application methods is limited. The viscosity is preferably to be selected so that application can occur at a temperature below 80° C., in particular below 50° C. At these low temperatures, no damage to the thin outer layer occurs.

The pressure-sensitive adhesive precursor suitable according to the present invention is to be crosslinkable by means of radiation-crosslinkable groups. Crosslinking generates a non-flowable, permanently contact-adhesive layer that exhibits good adhesion to the substrate of the outer layer.

Mono-, di- or higher-functional acrylate or methacrylate esters are a constituent of an adhesive precursor suitable according to the present invention. Such acrylate or methacrylate esters encompass, for example, esters of acrylic acid or methacrylic acid with aromatic, aliphatic, or cycloaliphatic polyols, or of polyether alcohols.

Esters of (meth)acrylic acid with monovalent alcohols can be used, for example, as a monofunctional acrylate ester. These are, for example, aliphatic and/or aromatic alcohols having one OH group. The number of carbon atoms can preferably be between 1 and 30 carbon atoms. Examples of such alcohols are methanol, ethanol, propanol, butanol, hexanol, octanol, decanol, or isomers thereof, higher homologs of the alkanols, alkylphenols such as nonylphenols, monofunctional low-molecular-weight polyethers such as single-end etherified polyethylene, polypropylene, polybutylene ethers having up to 10 repetitive units. Such alcohols can be converted to the corresponding esters using (meth)acrylic acid, in accordance with methods known to the skilled artisan.

A similar type of reaction is also possible with the polyols described below.

Examples of suitable compounds are acrylic acid or methacrylic acid esters of the aromatic, cycloaliphatic, aliphatic, linear, or branched C1-30 monoalcohols, or of corresponding ether alcohols. Examples of such compounds are 2-ethylhexyl acrylate, octyl/decyl acrylate, isobornyl acrylate, 3-methoxybutyl acrylate, 2-phenoxyethyl acrylate, benzyl acrylate, or 2-methoxypropyl acrylate.

A large number of polyols can be used as polyols for the manufacture of multifunctional (meth)acrylate esters. These are, for example, aliphatic polyols having 2 to 4 OH groups per molecule and 2 to 30 approximately carbon atoms. Suitable aliphatic polyols are, for example, ethylene glycol, 1,2- or 1,3-propanediol, 1,4-butanediol, 1,3-butanediol, 2,3-butanediol, 1,4-butenediol, 1,5-pentanediol, pentenediols, 1,6-hexanediol, 1,8-octanediol, dodecanediol, and higher homologs, isomers, and mixtures of such compounds.

Higher-functional alcohols are likewise suitable, for example glycerol, trimethylolpropane, pentaerythritol, or sugar alcohols such as sorbitol or glucose, as well as oligomeric ethers or reaction products with ethylene oxide or propylene oxide.

The reaction products of low-molecular-weight polyfunctional alcohols with alkylene oxides (so-called polyether polyols) can also be used as a polyol component for manufacturing the acrylate or methacrylate esters. The alkylene oxides by preference have two to approximately four carbon atoms. The reaction products of ethylene glycol, propylene glycol, the isomeric butanediols or hexanediols, glycerol, trimethylolethane or trimethylolpropane, pentaerythritol with ethylene oxide, propylene oxide, or butylene oxide, or mixtures thereof are, for example, suitable.

Examples of such (meth)acrylate esters are neopentyl glycol di(meth)acrylate, 1,8-octanediol di(meth)acrylate, butanediol di(meth)acrylate, 1,6-hexanediol di(meth)acrylate, trimethylolpropane tri(meth)acrylate, pentaerythritol tetra(meth)acrylate, and (meth)acrylate esters of sorbitol and of other sugar alcohols, ethylene oxide-modified neopentyl glycol di(meth)acrylates, propylene oxide-modified neopentyl glycol di(meth)acrylates, ethylene oxide-modified or propylene oxide-modified 1,6-hexanediol di(meth)acrylates, polyethylene glycol di(meth)acrylates, polypropylene glycol di(meth)acrylates, pentaerythritol tri(meth)acrylate, dipentaerythritol tetra(meth)acrylate, or mixtures thereof.

Reaction products based on polyether diols or triols or polyalkylene diols with (meth)acrylic esters having a molecular weight (Mn) from 200 to 3000 g/mol, by preference from 300 to 2000 g/mol, in particular up to approximately 1000 g/mol, are particularly suitable.

A further constituent of the adhesive precursors suitable according to the present invention is urethane (meth)acrylates. These are reaction products of alcohols, in particular monoalcohols, diols, and/or triols, with di- or triisocyanate compounds. The quantitative ratios in this context are selected so that terminally NCO-functionalized prepolymers are obtained. In particular, the prepolymers are intended to be linear, i.e. to be manufactured predominantly from monoalcohols or diols and diisocyanates. An additional use of small proportions of trifunctional polyols or isocyanates is possible. Such PU prepolymers can then be converted, with OH-reactive (meth)acrylic compounds, into the PU (meth)acrylates.

The monomeric di- or triisocyanates that are known for adhesive utilization can be used. Examples of suitable monomeric polyisocyanates are 1,5-naphthylene diisocyanate, 2,2′-, 2,4- and/or 4,4′-diphenylmethane diisocyanate (MDI), hydrogenated MDI (H₁₂MDI), allophanates of MDI, xylylene diisocyanate (XDI), tetramethylxylylene diisocyanate (TMXDI), 4,4′-diphenyldimethylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane 1,4-diisocyanate, hexane 1,6-diisocyanate (HDI), dicyclohexylmethane diisocyanate, cyclohexane 1,4-diisocyanate, ethylene diisocyanate, trimethylhexamethylene diisocyanate, 1,4-diisocyanatobutane, 1,12-diisocyanatododecane, dimer fatty acid diisocyanate.

Polyisocyanates that are produced by trimerization or oligomerization of diisocyanates, or by the reaction of diisocyanates with polyfunctional hydroxyl- or amino-group-containing compounds, are suitable as trifunctional isocyanates.

Low-molecular-weight polymers selected from polyester, polyether, polycarbonate, or polyacetal polyols that comprise terminal OH groups, or aliphatic or aromatic univalent to trivalent alcohols, having a molecular weight (Mn) from approximately 200 to 5000 g/mol (arithmetically averaged M_{N} as can be determined by GPC), are suitable, for example, for use as a polyol.

Suitable polyesters can be obtained by polycondensation of acid and alcohol components. Suitable polycarboxylic acids are those having an aliphatic, cycloaliphatic, aromatic, or heterocyclic basic structure. A plurality of polyols can be used as diols for reaction with the polycarboxylic acids. For example, aliphatic polyols having two OH groups per molecule and 2 to 20 carbon atoms are suitable. It is furthermore possible to use polyether polyols, obtained preferably by reacting low-molecular-weight polyols with alkylene oxides having two to four carbon atoms. Also suitable as a polyol are polyacetals that comprise terminal OH groups. Further polyols can be selected on the basis of polycarbonates or polycaprolactones. Further suitable polyols can be manufactured on the basis of polyacrylates. These are polymers manufactured by polymerization of poly(meth)acrylic esters. The oligomeric polyols are intended to contain 1 to 3 OH groups, in particular 2 terminal OH groups.

The polyols suitable for manufacturing the PU prepolymers are to have a molecular weight of up to 5000 g/mol. The molecular weight is, in particular, to be less than 3000 g/mol. In the case of polyether polyols, the molecular weight is to be between 200 and 2000 g/mol, in particular between 400 and 1000 g/mol. In the case of polyester polyols, the molecular weight is preferably to be less than 1500 g/mol. Linear polyether polyols are particularly suitable.

Suitable monofunctional compounds are, for example, aliphatic alcohols having 1 to 30 carbon atoms, for example ethanol, propanol, butanol, hexanol, octanol, and higher homologs, as well as the corresponding thio compounds. Aromatic alcohols can also be used, for example alkylphenols such as nonylphenol, or monohydroxy- or monoaminofunctional oligomeric ethers. The functional group is to be, in particular, an OH group.

Higher-functional aliphatic polyols are also suitable, in particular diols. Suitable compounds are, for example, polyols having 2 to 40 carbon atoms, for example ethylene glycol, propanediol, butanediol, and higher homologs.

Reaction of the polyols with the polyisocyanates can be accomplished in known fashion, for example in the presence of solvents, but it is preferable to work in solvent-free form. The temperature is usually elevated, for example between 40 and 80° C., in order to accelerate the reaction. If applicable, catalysts that are usual in polyurethane chemistry, for example dibutyltin dilaurate, dimethyltin dineododecanoate, or diazabicyclooctane (DABCO), can be added to the reaction mixture in order to accelerate the reaction.

In a further reaction, the NCO groups are then reacted with compounds which carry a functional group that can react with isocyanates and that comprises, as a further functional group, a double bond crosslinkable by radical polymerization. These usually have a molecular weight of less than 1000 g/mol.

Examples of such compounds are esters of α-β-unsaturated carboxylic acids with low-molecular-weight, in particular aliphatic, alcohols that also carry a further OH group in the alkyl residue. Corresponding OH-group-carrying esters are, for example, 2-hydroxyethyl(meth)acrylamide, 2-hydroxyethyl (meth)acrylate, 2-hydroxypropyl (meth)acrylate, 3-hydroxypropyl (meth)acrylate, 3-hydroxypropyl(meth)acrylamide, N-hydroxyethyl(meth)acrylamide, reaction products of glycidyl ethers or esters with acrylic or methacrylic acid, adducts of ethylene oxide or propylene oxide with (meth)acrylic acid, reaction products of hydroxyl acrylates with s-caprolactone, or partial transesterification products of polyalcohols, such as pentaerythritol, glycerol, or trimethylolpropane, with (meth)acrylic acid.

Included among the adjuvants and additives additionally usable in the context of the present invention in the pressure-sensitive adhesive precursor are, for example, plasticizers, stabilizers, antioxidants, adhesion promoters, resins, nonreactive polymers, dyes, fillers, or pigments.

In an embodiment, the suitable pressure-sensitive adhesive contains at least one tackifying resin. The resin produces additional tackiness. All resins that are compatible with the pressure-sensitive adhesive and with the adhesive precursor, i.e. that form a largely homogeneous mixture, can be used in principle.

These are, in particular, resins that possess a softening point from 70 to 140° C. (ring and ball method, DIN 52011). These are, for example, aromatic, aliphatic, or cycloaliphatic hydrocarbon resins, as well as modified or hydrogenated versions thereof. Examples thereof are aliphatic or alicyclic petroleum hydrocarbon resins and hydrogenated derivatives thereof. Further resins usable in the context of the invention are, for example, hydroabietyl alcohol and esters thereof, in particular esters with aromatic carboxylic acids such as terephthalic acid and phthalic acid; modified natural resins such as resin acids from balsam resin, tall resin, or wood rosin, e.g. partly or fully saponified balsam resin; alkyl esters of optionally partly hydrogenated colophon having low softening points, for example esters of methyl glycol, diethylene glycol, glycerol, and pentaerythritol; terpene resins, in particular terpolymers or copolymers of terpene, such as styrene terpene, α-methylstyrene terpene, phenol-modified terpene resins, as well as hydrogenated derivatives thereof; acrylic acid copolymerizates, by preference styrene-acrylic acid copolymers, and resins based on functional hydrocarbon resins.

In a further embodiment, the resins are types that are liquid at room temperature. The viscosity is preferably to be below 200,000 mPas, in particular from 1000 to 100,000 mPas. Mixtures of solid and liquid resins are also possible.

The resins generally possess a low molecular weight below 1500 g/mol, in particular below 1000 g/mol. They can be chemically inert, or also carry functional groups such as double bonds or OH groups. The resin can be used in a quantity from 0 to 70 wt %, preferably from 10 to 40 wt %, based on the adhesive precursor.

A photoinitiator that, upon irradiation with light of a wavelength from approximately 215 nm to approximately 480 nm, is capable of initiating a radical polymerization of olefinically unsaturated double bonds is used as a further necessary constituent of the pressure-sensitive adhesive or of a precursor. All commercially usual photoinitiators that are compatible with the pressure-sensitive adhesive precursors suitable according to the present invention are suitable in principle in the context of the present invention.

These are, for example, all Norrish Type I fragmentation substances, and Norrish Type II substances. Such initiators are known to the skilled artisan and can be procured, for example, under the trade names Irgacure®, Darocure®, Speedcure®. Also suitable are benzophenone, thioxanthone, 2,4,6-trimethylbenzenediphenylphosphine oxide, and corresponding derivatives. The quantity of initiators is from 0.1 to 5 wt %, in particular up to 3 wt %.

Small proportions of thermoplastic polyethers, polyesters, polyolefins, polyacrylates, or polyamides can optionally be added as nonreactive polymers. These are to comprise no radiation-reactive groups, but other functional groups such as OH, NH, or epoxy groups can be contained. These polymers influence the cohesion of the crosslinked adhesive.

In a particular embodiment, the adhesive is colored. This can be achieved by means of pigments or dyes. These are selected so that they do not impede radiation crosslinking.

The adhesive precursors that are suitable according to the present invention contain 15 to 60 wt % of at least one urethane-acrylate compound, 5 to 45 wt % of at least one (meth)acrylate ester, and 5 to 40 wt % of a hydrocarbon resin, as well as 0.1 to 15 wt % additives, for example a photoinitiator, the sum to be equal to 100%. The composition is, in particular, solvent-free.

The pressure-sensitive adhesive precursors usable according to the present invention generally have a viscosity at 80° C. of less than 5000 mPas (Brookfield RVT at indicated temperature, 50 rpm, EN ISO 2555). In preferred embodiments of the invention, the viscosity of the adhesive is selected so that at typical processing temperatures it has a viscosity from 200 mPas to approximately 3000 mPas, in particular below 1500 mPas. Suitable processing temperatures are, for example, 20 to approximately 80° C., in particular below 50° C.

The liquid or pasty adhesive precursors that are suitable according to the present invention are intended to be applied onto the outer side of the outer layer. This is possible using methods known in principle to the skilled artisan. The adhesive can be applied onto the surface in this context, for example, with a nozzle or with a spray apparatus. It is particularly preferred according to the present invention, however, to apply the pressure-sensitive adhesive precursor onto the surface of the outer layer using the printing method. This can be accomplished over the entire surface; it is possible to apply patterns, or predetermined regions are not coated with the adhesive precursor. Because of the low application temperature of the pressure-sensitive adhesive precursor, it is possible to ensure that the outer layer to be coated, i.e. for example the film, is not thermally stressed, and no particular measures need to be taken in order to avoid thermal damage to the outer layer.

It can be advantageous to select an application temperature of more than 25° C. Flow onto the substrate surface, and thus adhesion, are thereby improved, and a thin layer thickness can also be achieved as a result of the low viscosity.

Immediately after application of the adhesive precursor, it is crosslinked by actinic radiation. This can involve electron radiation, but UV radiation, in particular UV-C radiation, is preferred. The wavelength can range from 210 to 450 nm. The radiation intensity can be adapted to the adhesive and to the initiator that is used. Irradiation can occur continuously, or flash irradiation is performed; the irradiation time in this context can be from 0.01 second to 10 seconds. The equipment and process parameters for crosslinking UV-active adhesives are known to the skilled artisan and can be selected appropriately.

Application using printing units furthermore makes it possible to apply the adhesive according to the present invention in predefined shapes, for example written characters, logos, patterns, figures, or the like. It is optionally possible to generate a surface imprinted in color. The coated area can also be applied only on subregions; in most cases, more than 50% of the area is covered.

After crosslinking of the liquid adhesive precursor, a continuous or shaped layer of the pressure-sensitive adhesive (PSA) is obtained on the outer layer. Good flow onto the substrate surface is ensured by the low viscosity of the adhesive. Adhesion of the PSA layer onto the substrate is further enhanced by irradiation and radical crosslinking.

The adhesive layer can additionally have a protective layer applied onto it. The latter is made up of anti-adhesive-coated material that adheres onto the adhesive but can easily be removed from the adhesive surface by being pulled off. These are known coated or uncoated papers or films (release liners). The protective layer is anti-adhesive coated, or is made up of poorly adhesive material. They are known to the skilled artisan and can involve, for example, silicone-coated paper or films.

The process of manufacturing multiple-ply hygiene items is accelerated by the method according to the present invention. Fast coating is achieved by applying a printable adhesive precursor that is liquid at low temperature. By means of radiation crosslinking, an adhesive layer fixedly joined to the outer layer is produced immediately after application. It is possible to ensure, by way of the method parameters, that thermal damage to the material of the outer layer does not occur.

With the use of colored adhesives it is possible to impart color to the outer side of the hygiene item or to apply visually attractive patterns.

The multiple-ply fluid-absorbing hygiene item according to the present invention can be configured on the inner side in accordance with known embodiments. A layer of pressure-sensitive adhesive, which can be shaped uniformly or as a pattern, is applied onto the outer layer on the outer side. The adhesion of this pressure-sensitive adhesive layer to the fiber fabric or film of the outer side is good.

During use, the outer side is located opposite a garment made of fabric. The hygiene item is then fastened in place under light pressure. The adhesion of the PSA layer to the garment is, however, substantially less than to the outer layer, thus ensuring that thanks to application of the UV-crosslinking adhesive suitable according to the present invention, residue-free removal from the clothing surface is possible.

1. A multiple-ply fluid-absorbing hygiene item comprising an inner layer, an outer layer and a UV-crosslinked pressure-sensitive adhesive coated on the outer layer, wherein the UV-adhesive is prepared from a liquid pressure-sensitive adhesive precursor which has a viscosity less than 5000 mPas at 80° C.

2. The hygiene item according to claim 1, wherein the outer layer has a softening point below 130° C.

3. The hygiene item according to claim 1, wherein the outer layer is a polyolefin film or polyolefin nonwoven fabric.

4. The hygiene item according to claim 3, wherein the outer layer is a polyethylene film with a softening point below 120° C.

5. The hygiene item according to claim 1, wherein the precursor comprises:
(a) 5 to 45 wt % (meth)acrylate ester;
(b) 15 to 60 wt % of a urethane-acrylate;
(c) 5 to 40 wt % of at least one resin; and
(d) 0.1 to 15 wt % additive,
wherein the sum of the wt % is 100 wt %.

6. The hygiene item according to claim 5, wherein the precursor comprises 45 to 50 wt % of a urethane (meth)acrylate.

7. The hygiene item according to claim 5, wherein the (meth)acrylate ester is selected from the group consisting of 2-ethylhexyl acrylate, octyl/decyl acrylate, isobornyl acrylate, 3-methoxybutyl acrylate, 2-phenoxyethyl acrylate, benzyl acrylate, 2-methoxypropyl acrylate, neopentyl glycol di(meth)acrylate, 1,8-octanediol di(meth)acrylate, butanediol di(meth)acrylate, 1,6-hexanediol di(meth)acrylate, trimethylolpropane tri(meth)acrylate, pentaerythritol tetra(meth)acrylate, and (meth)acrylate esters of sorbitol and of other sugar alcohols, ethylene oxide-modified neopentyl glycol di(meth)acrylates, propylene oxide-modified neopentyl glycol di(meth)acrylates, ethylene oxide-modified or propylene oxide-modified 1,6-hexanediol di(meth)acrylates, polyethylene glycol di(meth)acrylates, polypropylene glycol di(meth)acrylates, pentaerythritol tri(meth)acrylate, dipentaerythritol tetra(meth)acrylate, and mixtures thereof.

8. The hygiene item of claim 5 wherein the additive is selected from the group consisting of a plasticizers, stabilizers, antioxidants, adhesion promoters, resins, nonreactive polymers, dye, filler, colorant and pigment

9. The hygiene item of claim 8 wherein the additive is a dye, filler, colorant or pigment.

10. The hygiene item according to claim 1, wherein the precursor has a viscosity of from 200 to 3000 mPas at 20 and 50° C.

11. The hygiene item of claim 1, wherein the precursor is coated on at least 50% of the area of the outer layer.

12. The hygiene item of claim 1, wherein the adhesion of the adhesive is substantially less to a textile fabric than the outer layer.

13. A method for manufacturing a multiple-ply fluid-absorbing hygiene item of claim 1 comprising:
(a) applying the precursor on the outer layer at temperature below 80° C.;
(b) cross-linking the precursor with a UV radiation to form the UV-crosslinked pressure-sensitive adhesive; and
(c) covering the UV-crosslinked pressure-sensitive adhesive with a removable protective layer.

14. The method according to claim 14, wherein the precursor is applied onto the outer layer by printing, spraying, blade-coating, or rolling.

15. The method of claim 15 wherein the precursor is applied in a shape of characters, logos, figures and pattern.

16. The method according to claim 13, wherein the UV radiation has a wavelength between 210 and 450 nm.
